(19) United States
(12) Patent Application Publication
(10) Pub. No.: US 2013/0174035 A1
(43) Pub. Date: Jul. 4, 2013

(54) SYSTEMS AND METHODS FOR REPRESENTING A CONTENT DEPENDENCY LIST

(71) Applicant: Eric W. Grab, San Diego, CA (US)

(72) Inventor: Eric W. Grab, San Diego, CA (US)

(73) Assignee: United Video Properties, Inc., Santa Clara, CA (US)

(21) Appl. No.: 13/340,880

(22) Filed: Dec. 30, 2011

(51) Int. Cl. G06F 3/01

(52) U.S. Cl. 715/716

(57) ABSTRACT

Systems and methods for providing an enhanced viewing experience for a user of an interactive media guidance application are provided. In some aspects, an interactive media guidance application implemented on control circuitry receives a selection of a media asset from a user. The control circuitry analyzes the media asset to determine a context for a portion of the media asset. The control circuitry identifies content related to the portion of the media asset based on the context. The identified content is different from the media asset and is displayed in response to the user selection of the media asset.

### BACKGROUND OF THE INVENTION

A viewer of a show may not always have the context necessary to fully comprehend the events unfolding in the show being watched. For example, a user viewing the fourth episode of season four of LOST, an ABC dramatic television series, may have a difficult time following the events of the episode if the user has not previously seen the preceding episodes (LOST is a trademark owned by Disney Enterprises, Inc.). One option may be for the user to view all previously aired episodes of LOST to acquire background information to better understand the events in the episode. However, not only would viewing all previously aired episodes take a long period of time, but also the user may still miss some of the needed background information as he is overburdened with viewing a vast number of episodes.

In another example, a user viewing a comedy news show, such as THE COLBERT REPORT, may not be aware of the latest news and, therefore, may be unable to fully appreciate the events and sketches presented in the show. One option may be for the user to view the news or read a newspaper on a regular basis. However, the user may still miss the particular news story on which the sketches are based.

### SUMMARY OF THE INVENTION

In view of the foregoing, systems and methods for enhancing a viewing experience for a user of an interactive media guidance application are provided. The viewing experience is enhanced by providing a context for media content being viewed by the user. Providing the context may include, for example, displaying content related to media content being viewed. The related content may be identified and arranged in a playlist based on an ordering scheme. The related content may provide background information for the user when viewing an event included in the media content. The related content may precede or follow the event included in the media content and clarify a meaning of the included event to the user. For example, the related content may include an audio clip, a video clip, an image, a document, a program, or any other suitable media.

In some aspects, an interactive media guidance application implemented on control circuitry receives a selection of a media asset from a user. The control circuitry analyzes the media asset to determine a context for a portion of the media asset. The control circuitry identifies content related to the portion of the media asset based on the context. The identified content is different from the media asset. The control circuitry determines an ordering scheme for the identified content, and arranges the content in a playlist based on the ordering scheme. The playlist is played in response to the user selection of the media asset.

In some embodiments, the portion of the media asset includes a scene of the media asset and viewing the content selected based on the context aids the user to understand the scene. In some embodiments, the context relates to background information for the user. The background information relates to an event displayed in the media asset being viewed by the user. In some embodiments, the context aids in providing related content to the user. The related content may precede or follow an event displayed in the media asset and clarifies a meaning of the event to the user.

In some embodiments, the control circuitry determines the context for the media asset by identifying a keyword from a detailed description of the media asset. The control circuitry identifies related content based on the identified keyword(s). In some embodiments, the control circuitry determines the context for the media asset by searching a social network or a blog. In some embodiments, the control circuitry displays to the user an option to play the playlist accompanied by, e.g., a list of related content in the playlist. The control circuitry plays the playlist in response to a user selection of the option. In some embodiments, the control circuitry automatically determines when to play the playlist to the user during playback of the media asset.

In some embodiments, the ordering scheme is based on one or more criteria such as date, length, type of media, source, ratings, and/or number of views. In some embodiments, the control circuitry displays the related content in an overlay, a picture-in-picture display, or another suitable display. In some embodiments, the control circuitry, implemented in a first user device, is configured to play the playlist at a second, different device. For example, the related media content may be displayed on a mobile device, a tablet device, a desktop computer, a laptop, or any other suitable device. The control circuitry may pause playback on the first device while the user views the related content on the second device.

In some embodiments, the media asset selected by the user includes metadata for related content. For example, the metadata may include context keywords, a list of related content, or a hyperlink to such information. The control circuitry may identify related content based on a combination of the context keywords, the list of related content, the social network or blog, the detailed description for the media asset, or any other suitable parameter.

In some embodiments, the media asset includes an episode of a series and the identified content includes clips from other episodes in the series.

In some aspects, a system for an interactive media guidance application that enhances viewing experience of a user is implemented at least partially on user equipment including a user input interface, a display device, and control circuitry configured to execute the functionality described above.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with an embodiment of the invention;

FIG. 4 is a diagram of an illustrative cross-platform interactive media system in accordance with an embodiment of the invention;

FIGS. 5A and 5B show illustrative display screens that may provide context of a selected media asset to the user in accordance with an embodiment of the invention;

FIG. 6 shows an illustrative display screen that may provide context of a selected media asset to the user in accordance with another embodiment of the invention;

FIG. 7 shows an illustrative display screen where context-related media is displayed to a user in accordance with an embodiment of the invention;

FIG. 8 shows an illustrative display screen where context-related media is displayed to a user in accordance with another embodiment of the invention;

FIG. 9 shows an illustrative cross-platform interactive media system where context-related media is displayed to a user on a different device in accordance with an embodiment of the invention;

FIGS. 10A and 10B show illustrative data structures that provide context-related information in accordance with an embodiment of the invention;

FIG. 11 shows an illustrative flow diagram for providing a context for media content being viewed by the user in accordance with an embodiment of the invention;

FIG. 12 shows an illustrative flow diagram for providing a context for an episode of a series being viewed by the user in accordance with an embodiment of the invention.

### DETAILED DESCRIPTION OF EMBODIMENTS

The systems and methods described herein enhance the viewing experience for a user of an interactive media guidance application by providing a context for media content selected for viewing. Providing the context may include, for example, displaying content related to media content being viewed. The related content may be identified and arranged in a playlist based on an ordering scheme having criteria such as date, length, type of media, source, ratings, number of views, or any other suitable criteria or a combination thereof. The related content may provide background information for the user when viewing an event included in the media content. The related content may precede or follow the event included in the media content and clarify a meaning of the included event to the user. For example, the related content may include an audio clip, a video clip, an image, a document, a media program, or any other media or content discussed below or combination thereof.

The need for providing context or related information to a user may arise in various cases. For example, a user viewing the fourth episode of season four of LOST, an ABC television series, may have a difficult time following the events of the episode. Control circuitry, on which the interactive media guidance is implemented, may search for and/or retrieve content (including audio, video, text, or any other suitable format) that may provide background information regarding a particular event in the episode. The control circuitry may gather, e.g., clips from past episodes that relate to the event under scrutiny and display a playlist of these clips to the user. The clips may be arranged in the playlist based on an ordering scheme having criteria such as date, length, type of media, source, ratings, number of views, or any other suitable criteria or a combination thereof. The playlist may be displayed in response to user selection or automatically shown at a particular moment during display of the current episode. Once the user has viewed one or more of the related content, he may return to viewing the episode with a better understanding of the event in progress. An advantage of this approach may be that the user need not view all previously aired episodes of LOST to acquire the needed background information. Such an approach may be especially helpful to a casual viewer who does not intend to watch the entire series.

In another example, a user viewing a comedy news show, such as THE COLBERT REPORT, may not be aware of the latest news and, therefore, may be unable to fully appreciate the events and sketches presented in the program. Control circuitry, on which the interactive media guidance is implemented, may search for and/or retrieve content (including audio, video, text, or any other suitable format) that may provide background information regarding a particular news event discussed in the program. The control circuitry may gather news clips and news articles that relate to the news event under scrutiny and display a playlist of these clips and articles to the user. The clips may arranged in a playlist based on an ordering scheme having criteria such as date, length, type of media, source, ratings, number of views, or any other suitable criteria or a combination thereof. For example, the ordering scheme may include a criteria that is a weighted combination of date and source. The ordering scheme may arrange recently available content from a news source towards the top of the playlist in order to provide the user with the most up-to-date information regarding the news event under scrutiny. As discussed earlier, the playlist may be displayed in response to user selection or automatically shown at a particular moment during display of the current program. The user may choose to view the related content before, during, or after the news event segment in the program. As such, the viewer need not search for the news event on, e.g., the Internet, which may avoid the user being distracted and discontinuing to pay attention to the comedy news program. In some embodiments, functionality for providing context of programs to a user may be implemented in an interactive media guidance application, the details for which are discussed further below.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. The various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

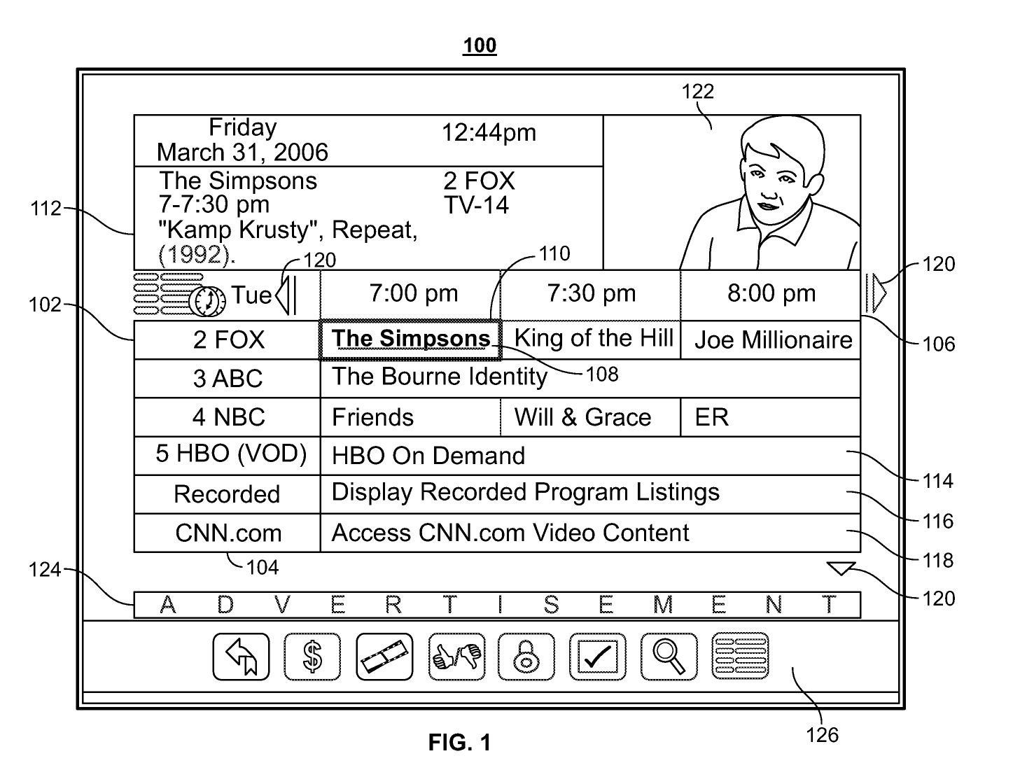

FIGS. 1-2 show illustrative display screens that may be used to provide media guidance data. The display screens shown in FIGS. 1-2 and 5A-9 may be implemented on any suitable user equipment device or platform. While the displays of FIGS. 1-2 and 5A-9 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, options to view related content that provides background information or context for a selected media content, options to view the related content on a second screen device, options to view additional related content, options to add related content to a queue for later viewing, options to resume playback of the selected media content, options to specify an ordering scheme and/or criteria for the ordering scheme, or other suitable options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

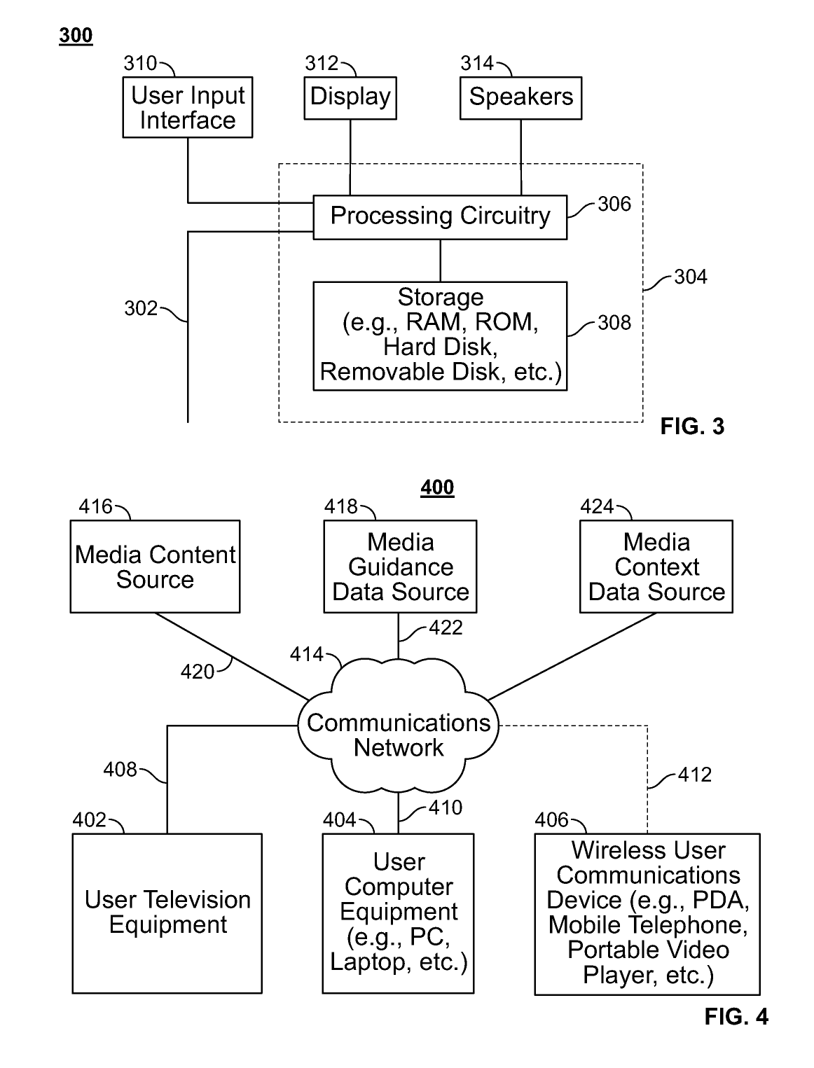

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

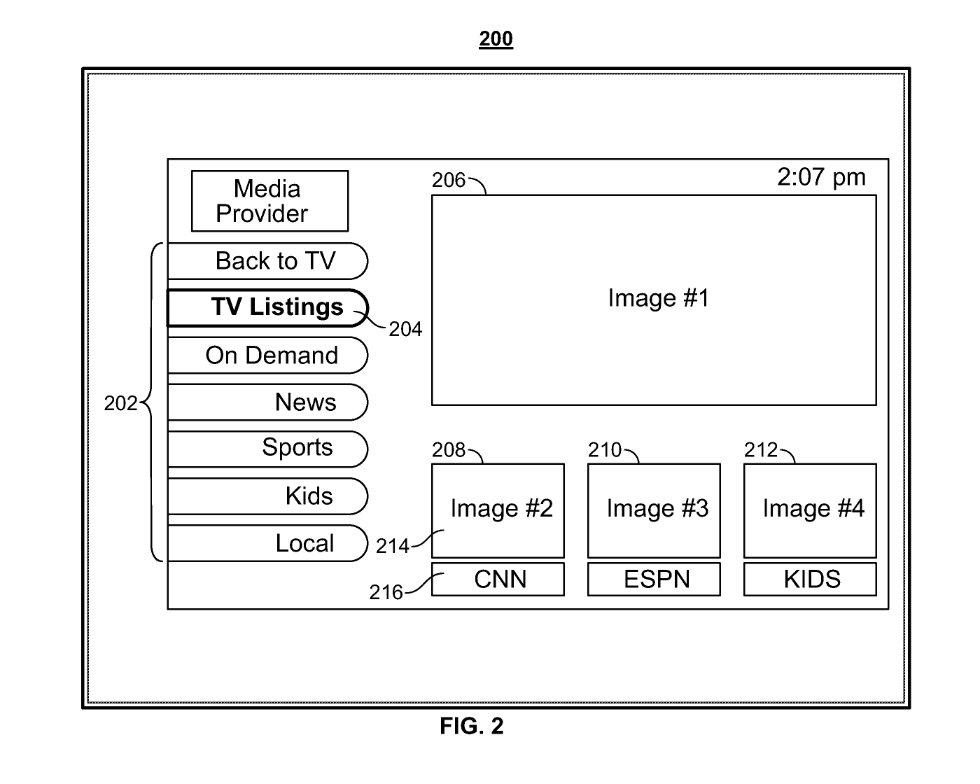

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). In some embodiments, control circuitry 304 executes instructions for retrieving metadata for a selected media asset, identifying context keywords, searching for content related to the media asset that provides background information or context, determining an ordering scheme for the related content, and/or generating a playlist of the identified content based on the ordering scheme for display to the user.

In client-server based embodiments, control circuitry 304 may include communications circuitry suitable for communicating with a guidance application server or other networks or servers. For example, control circuitry 304 may communicate with a remote server that can search for context-related media. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308. In some embodiments, memory as described above stores metadata for media assets that may be used to determine context and search for context-related media.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. In some embodiments, the second screen is configured to display related content that provides background information or a context to media content selected for playback on the first user equipment device. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416, media guidance data source 418, and media context data source 424, coupled to communications network 414 via communication paths 420 and 422, respectively. Paths 420 and 422 may include any of the communication paths described above in connection with paths 408, 410, and 412. Communications with the content source 416, media guidance data source 418, and the media context data source 424 may be exchanged over one or more communications paths, but are shown as a single path in FIG. 4 to avoid overcomplicating the drawing. In addition, there may be more than one of each of content source 416, media guidance data source 418, and media context data source 424, but only one of each is shown in FIG. 4 to avoid overcomplicating the drawing. (The different types of each of these sources are discussed below.) If desired, one or more of content source 416, media guidance data source 418, and media context data source 424 may be integrated as one source device. Although communications between sources 416, 418, and 424 with user equipment devices 402, 404, and 406 are shown as through communications network 414, in some embodiments, sources 416, 418, and 424 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media context data source 424 may provide context data, such as context keywords, a list of related content, an other suitable data described earlier. Media context data may be provided to the user equipment devices using any suitable approach. In some embodiments, the guidance application may be a stand-alone interactive television program guide that receives data via a data feed (e.g., a continuous feed or trickle feed). Media context data may be provided to the user equipment on a television channel sideband, using an in-band digital signal, using an out-of-band digital signal, or by any other suitable data transmission technique. Media context data may be provided to user equipment on multiple analog or digital television channels.

In some embodiments, context data from media context data source 424 may be provided to users' equipment using a client-server approach. For example, a user equipment device may pull media context data from a server, or a server may push media context data to a user equipment device. In some embodiments, a guidance application client residing on the user's equipment may initiate sessions with source 424 to obtain context data when needed, e.g., when the user equipment device receives a request from the user to receive data. Media context data may be provided to the user equipment with any suitable frequency (e.g., continuously, daily, a user-specified period of time, a system-specified period of time, in response to a request from user equipment, etc.). Media context data source 424 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance (or context) data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance (or context) data described above. In addition to content and/or media guidance (or context) data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content, guidance, and context data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416, one or more media guidance data sources 418, and one or more media context data sources 424. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications or the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

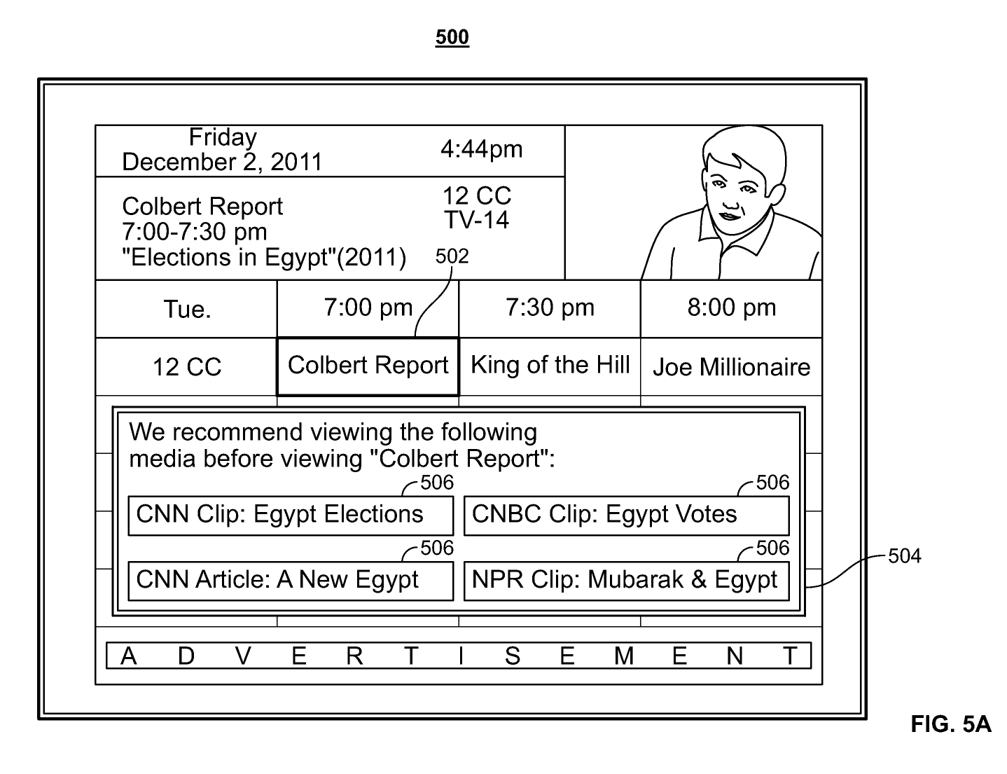

FIG. 5A shows an illustrative embodiment of a display screen for providing context of a selected media asset to the user of an interactive media guidance application. In FIG. 5A, display screen 500 may be generated automatically or responsive to a request from the user. In some implementations, control circuitry 304 may generate screen 500 in response to a user selection of content selected from screen 100 or 200, e.g., program 502 (“COLBERT REPORT”). Program 502 may be selected for immediate viewing or scheduled for viewing at a later time. Screen 500 includes window 504 that displays a list of content suitable for providing a context of program 502 to the user. In some implementations, the user may request window 504 from a menu (not shown) within the interactive media guidance application.

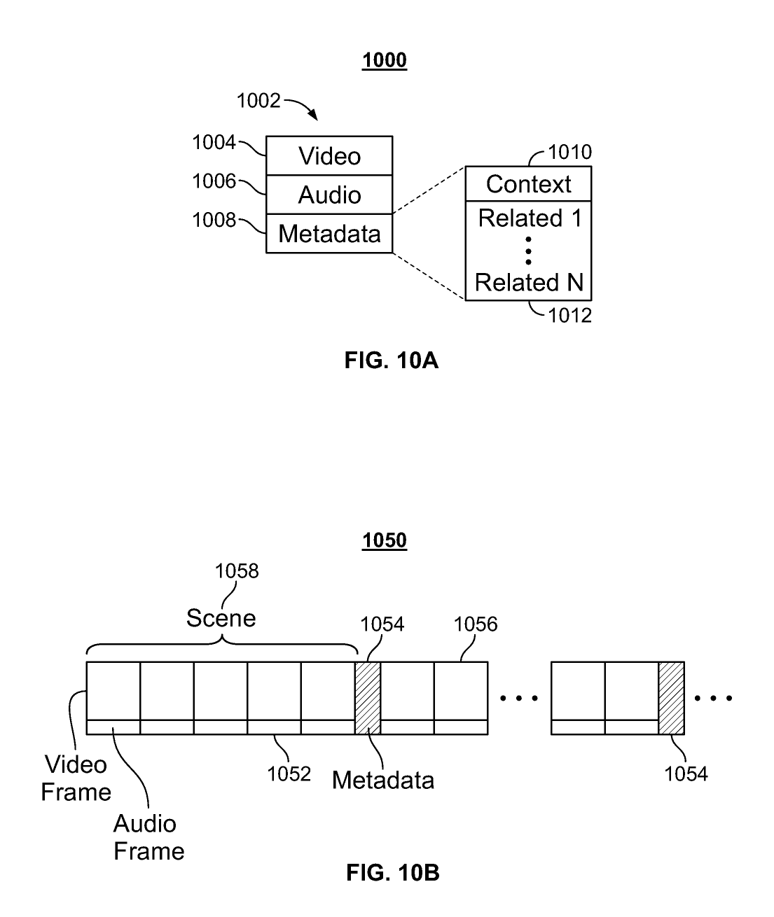

A user viewing program 502 (comedy news program, “COLBERT REPORT”) may not be aware of the latest news and, therefore, may be unable to fully appreciate the events and sketches presented in the program. In this embodiment, the selected program 502 includes events relating to “Egypt Elections.” Control circuitry 304 may identify “Egypt Elections” as the context for which related media is needed. Control circuitry 304 may generate keywords pertaining to the context and search media context data source 424 for content (including audio, video, text, and any other suitable format) related to the context based on the keywords that may provide background information regarding “Egypt Elections” to the user. Control circuitry 304 may retrieve a media context data structure (described further in relation to FIGS. 10A and 10B) and retrieve content from a storage device or from an external remote source (e.g., a website on the Internet). The search may be performed based on a detailed description for program 502, or metadata and/or other suitable media context data included in the media context data structure. In some embodiments, control circuitry 304 determines the context for the media asset by searching a social network or a blog. For example, control circuitry 304 may search for a social network or blog page (on FACEBOOK, TWITTER, MYSPACE, or any other such websites) relating to “Egypt Elections” and retrieve context keywords and/or content based on posts, links, images, documents, audio, video, or other suitable information included in the social network or blog page.

In embodiments where context for the media asset is determined by searching a social network website, control circuitry 304 retrieves login information for the social network website. Control circuitry 304 may retrieve login information from a user profile, via user input, or in any other suitable manner. In some embodiments, login information is not needed for publicly available webpages on certain social network websites. Control circuitry 304 establishes a communications link with the social network website via, e.g., the Internet or any other suitable network. Control circuitry 304 searches for available content such as posts, links, images, documents, audio, video, or other suitable information and retrieves any media related to the identified context (e.g., “Egypt Elections”). Control circuitry 304 may analyze and parse the source code (e.g., hypertext markup language (HTML)) to locate media relevant to the context. For example, control circuitry 304 may find a link to a news article regarding “Egypt Elections” posted by a friend of the user. Control circuitry 304 may retrieve the news article and include it in the list of related content to be displayed to the user.

In embodiments where context for the media asset is determined by searching a blog website, control circuitry 304 retrieves login information for the blog website. Control circuitry 304 may retrieve login information from a user profile, via user input, or in any other suitable manner. In some embodiments, login information is not needed for publicly available webpages on certain blog websites. Control circuitry 304 establishes a communications link with the blog website via, e.g., the Internet or any other suitable network. Control circuitry 304 searches for available content such as posts, links, images, documents, audio, video, or other suitable information and retrieves any media related to “Egypt Elections.” Control circuitry 304 may analyze the source code (e.g., hypertext markup language (HTML)) to locate relevant media. For example, control circuitry 304 may find a link to a video clip regarding “Egypt Elections” posted by a blogger on their webpage on the blog website. Control circuitry 304 may retrieve the video clip and include it in the list of related content to be displayed to the user.

In some embodiments, control circuitry 304 searches for news-related media such as electronic textual newspaper reports and videos of nightly news on news websites, e.g., CNN, or media websites, e.g., YOUTUBE, and retrieves any media related to “Egypt Elections.” For example, control circuitry 304 may perform a keyword search on news-related media websites for words related to the context (e.g., Egypt Elections). The media websites may return hits of electronic textual reports as well as audio and videos corresponding to the keyword. Control circuitry 304 may store the textual reports locally in memory for inclusion in a list of related content to be displayed to the user. Control circuitry 304 may process the videos that are identified to determine whether they correspond and are related to the context.

In some implementations, control circuitry 304 analyzes the retrieved media for references to “Egypt Elections.” For example, control circuitry 304 may analyze the text of the newspaper reports or audio transcripts of audio or videos of the nightly news. Control circuitry 304 may process audio or videos of the news-related media to identify a position within the audio or videos at which the references to the context are made (e.g., positions within the video pertaining to the “Egypt Elections” context). Control circuitry 304 may generate a clip of only the segment of the audio or video pertaining to the context and store the clip for inclusion in a list of related content to be displayed to the user. Alternatively, control circuitry 304 may store metadata in the list of related content. The metadata may include start and end markers for the portions of the audio or videos that pertain to the context.

Control circuitry 304 may display the clips (e.g., audio clips, video clips, electronic textual news clips, etc.) by dynamically seeking in the original content to the portion that pertains to the context. In some embodiments, control circuitry 304 arranges the clips in a playlist according to an ordering scheme. For example, control circuitry 304 may arrange the clips according to a date at which they became available to the public such that the oldest clips are displayed first. This allows the user to receive a chorological understanding of the events relating to the context (e.g., “Egypt Elections”). In another example, control circuitry 304 may arrange the clips according to type, such that video and audio clips are displayed first, and clips of the electronic textual news are displayed after. This allows the user to quickly obtain familiarity with the event from the video and audio clips, and then, if desired, obtain further understanding from in-depth clips of electronic textual news or articles. Additional details on ordering schemes are provided further below.

Control circuitry 304 gathers related media 506 that relate to “Egypt Elections.” Control circuitry 304 determines an ordering scheme for related media 506. Control circuitry 304 may select an ordering scheme automatically (e.g., default selection, previously selected, or another suitable option) or receive criteria from the user for the ordering scheme. The ordering scheme may be based on one or more criteria such as date, length, type of media, source, ratings, number of views, or any other suitable criteria or a combination thereof. For example, the ordering scheme may arrange related media 506 in chronological or reverse chronological order. In another example, the ordering scheme may include a criteria that is a weighted combination of date and source. The ordering scheme may arrange recently available content from a news source towards the top of the playlist in order to provide the user with the most up-to-date information regarding “Egypt Elections.” In yet another example, the ordering scheme may arrange related media 506 according to their receptive lengths. In yet another example, the ordering scheme may arrange related media 506 based on types of the respective media, e.g., audio, video, text, or any other suitable type. In yet another example, the ordering scheme may arrange related media 506 according to their respective sources, e.g., channel sources (e.g., CNN), satellite sources (e.g., XM RADIO), on-demand sources (e.g., VOD), Internet sources (e.g., streaming media, downloadable media), locally stored content (e.g., content stored on any user equipment device), or any other suitable source. In yet another example, the ordering scheme may arrange related media 506 according to user ratings for the respective media. In yet another example, the ordering scheme may arrange related media 506 according to number of views from other users for the respective media.

Control circuitry 304 arranges related media 506 in a playlist based on the selected ordering scheme and displays the playlist to the user in window 504. The user may choose to view one or more of the related content. If program 502 is a live broadcast, control circuitry may initiate recording of the program when window 504 is displayed. This ensures that the user can still return to viewing the program at the point it was left off after viewing the related media and understanding the relevant context. Alternatively, the user may select an option (“not shown”) to save the related media to a queue for later viewing. As such, the viewer need not search on his own for “Egypt Elections” on, e.g., the Internet, which may avoid the user being distracted and discontinuing to pay attention to program 502. This may be advantageous for advertisers and sponsors for program 502. By providing relevant context to the user, the advertisers and sponsors may ensure more exposure to their advertisements by retaining user focus on viewing program 502.

FIG. 5B shows another illustrative embodiment of a display screen for providing context of a selected media asset to the user of an interactive media guidance application. In FIG. 5B, display screen 550 may be generated automatically or responsive to a request from the user. Control circuitry 304 may generate screen 550 in response to a user input from user input interface 310 (e.g., a remote key press). Screen 550 includes window 554 that includes content suitable for providing a context of program 552 to the user. In some implementations, screen 550 may be generated automatically when the program 552 reaches a certain point during playback, e.g., the beginning of a certain event.

A user viewing program 552 (comedy program, “FAMILY GUY”) may not have the background information necessary to fully understand the events unfolding in the program. For example, the scene illustrated in FIG. 5B relates to a comedic fight scene between two characters in the show. However, a user who is viewing “FAMILY GUY” for the first time, or even a regular viewer who is unaware of the history between these two characters may not understand or appreciate the humor behind the scene. In such a situation, the user may lose interest in the current program and may even be turned away from future episodes of “FAMILY GUY.” To aid the user's understanding, control circuitry 304, on which the interactive media guidance is implemented, searches media context data source 424 for related content (including audio, video, text, and any other suitable format) that may provide background information to the user. Control circuitry 304 may retrieve a media context data structure (described further in relation to FIGS. 10A and 10B) and retrieve content from a storage device or from an external remote source (e.g., a website on the Internet). The search may be performed based on a detailed description for program 502, or metadata and/or other suitable media context data included in the media context data structure. In some embodiments, the control circuitry determines the context for the media asset by searching a social network or a blog for context keywords and/or content.

Control circuitry 304 gathers related media that relate to “FAMILY GUY.” Control circuitry 304 determines an ordering scheme for the related media. Control circuitry 304 may select an ordering scheme automatically (e.g., default selection, previously selected, or another suitable option) or receive criteria from the user for the ordering scheme. The ordering scheme may be based on one or more criteria such as date, length, type of media, source, ratings, number of views, or any other suitable criteria or a combination thereof. For example, the ordering scheme may arrange the related media in chronological or reverse chronological order. In another example, the ordering scheme may arrange the related media according to their receptive lengths. In yet another example, the ordering scheme may arrange the related media based on types of the respective media, e.g., audio, video, text, or any other suitable type. In yet another example, the ordering scheme may arrange the related media according to their respective sources, e.g., channel sources (e.g., CNN), satellite sources (e.g., XM RADIO), on-demand sources (e.g., VOD), Internet sources (e.g., streaming media, downloadable media), locally stored content (e.g., content stored on any user equipment device), or any other suitable source. In yet another example, the ordering scheme may arrange the related media according to user ratings for the respective media. In yet another example, the ordering scheme may arrange the related media according to number of views from other users for the respective media.

Control circuitry 304 may arrange the related media in a playlist based on the selected ordering scheme and display the playlist to the user. In the embodiment shown, control circuitry 304 finds related media “Chicken Fight (Family Guy)” and displays an option to view the media in window 554. The user may choose to view the media immediately (by selecting option 556, “NOW”), defer viewing and may save to a queue (by selecting option 558, “SAVE TO QUEUE”), or choose to never view the related media (by selecting option 560, “NEVER”). In some embodiments, if the user selects option 560, “NEVER,” a number of times above a set threshold, control circuitry 304 may disable further automatic prompts to the user that provide context. However, the user may still access window 554 manually, if desired. Such a scenario may occur if the user does not want any spoilers on the events unfolding in the program and would rather decipher the relationship between the two characters himself. Another such scenario may occur if the user is viewing program 552 with other people and does not want to disturb their viewing experience.

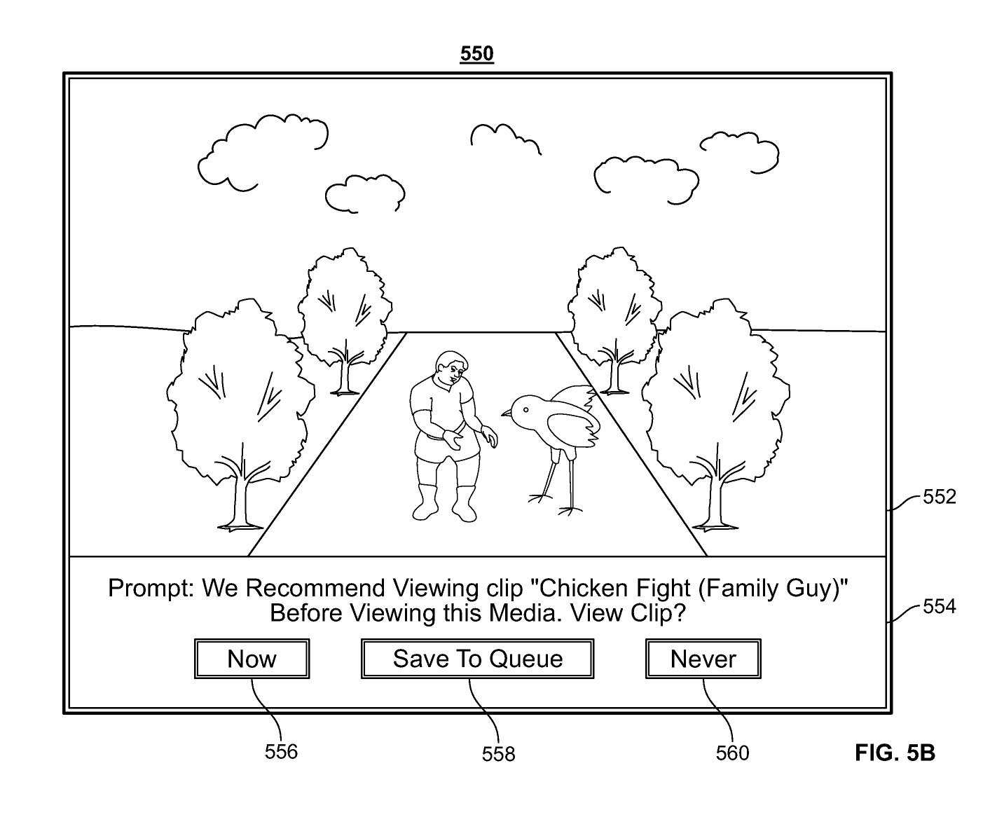

FIG. 6 shows another illustrative embodiment of display screen that may provide context of a selected media asset to the user of an interactive media guidance application. In FIG. 6, display screen 600 may be generated automatically or responsive to a request from the user. Screen 600 includes window 604 that includes content suitable for providing a context of program 602 to the user. In some implementations, screen 600 may be generated automatically when the program 602 reaches a certain point during playback. In the embodiment shown, the user is viewing the fourth episode of season four of LOST, an ABC television series. The user may experience difficulty following certain events in the episode. In response to user input or automatically, control 304 may search for and/or retrieve content (including audio, video, text, and any other suitable format) that may provide background information regarding a particular event in the episode. Control circuitry 304 may base the search on a media context data structure (described further in relation to FIGS. 10A and 10B) and retrieve content from a storage device or from an external remote source (e.g., a website on the Internet). The control circuitry may gather clips from past episodes that relate to the event under scrutiny. Control circuitry 304 determines an ordering scheme for the identified clips. Control circuitry 304 may select an ordering scheme automatically (e.g., default selection, previously selected, or another suitable option) or receive criteria from the user for the ordering scheme. The ordering scheme may be based on one or more criteria such as date, length, type of media, source, ratings, number of views, or any other suitable criteria or a combination thereof. For example, the ordering scheme may arrange the related content in chronological or reverse chronological order. Other suitable examples are described above in relation to FIGS. 5A and 5B. Control circuitry 304 may arrange the related media in a playlist based on the selected ordering scheme and display the playlist to the user.

In the embodiment shown, a prompt is displayed automatically in window 604 at a particular moment during playback of the current episode. The user may choose to view the recommended media immediately (by selecting option 606, “NOW”), defer viewing and may save to a queue (by selecting option 608, “SAVE TO QUEUE”), or choose to never view the recommended media (by selecting option 610, “NEVER”). In some embodiments, control circuitry 304 may display a playlist of the clips to the user in response to selecting option 606, “NOW”. Once the user has viewed one or more of the clips, he may return to viewing the episode with a better understanding of the event in progress. An advantage of this approach may be that the user need not view all previously aired episodes of LOST to acquire the needed background information. Such an approach may be especially helpful to a casual viewer who does not intend to view the entire series.

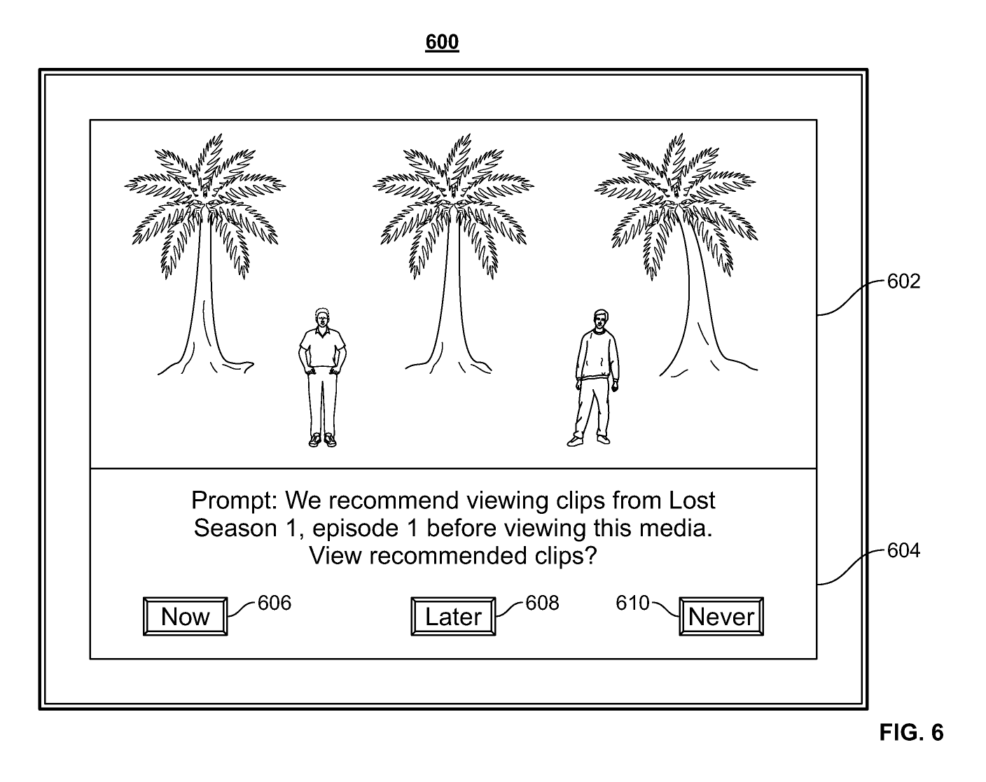

FIG. 7 shows an illustrative embodiment of a display screen where context-related media is displayed to a user of an interactive media guidance application. Display screen 700 includes overlay window 704 on top of program 702. When the user selects, e.g., option 606 (“NOW”), to view the recommended content, control circuitry 304 displays the content for the user in overlay window 704. Overlay window 704 may be positioned at any place on the display screen and may be sized accordingly. For example, overlay window 704 may cover the whole screen so that the user may best view the recommended content. In some embodiments, overlay window 704 is opaque while the remaining screen portion is translucent such that program 702 is visible. Program 702 may be paused at the point the overlay window 704 was initiated, and show the last viewed frame of the program. Alternatively, control circuitry 304 may continue playback of program 702 which may be visible through the translucent portion of the display screen.

In some embodiments, control circuitry 304 may accept user input to reposition and/or resize overlay window 704 or automatically reposition and/or resize overlay window 704 based on the user's profile or preferences. In some embodiments, once playback of recommended media in overlay window 704 is complete, control circuitry 304 prompts the user with a menu (not shown) having options to replay the content, choose another related content, and/or return to program 702. In some embodiments, once playback of recommended media in overlay window 704 is complete, control circuitry 304 automatically resumes playback of program 702 from the last saved position when playback was paused.

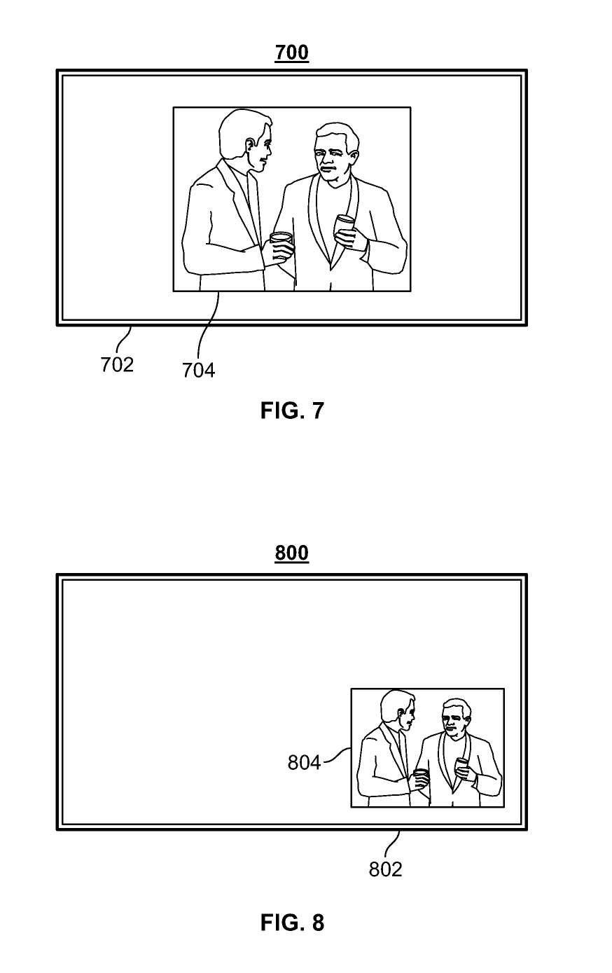

FIG. 8 shows another illustrative embodiment of a display screen where context-related media is displayed to a user of an interactive media guidance application. Display screen 800 includes picture-in-picture (PIP) window 804 on top of program 802. When the user selects, e.g., option 606 (“NOW”), to view the recommended content, control circuitry 304 displays the content for the user in PIP window 802. Similar to the embodiment discussed in FIG. 7, PIP window 804 may be positioned at any place on the display screen and may be sized accordingly. Program 802 may be paused at the point the overlay window 804 is initiated, and may show the last viewed frame of the program. Alternatively, a blank frame, a logo, or any other suitable screen may be displayed in place of program 802. In some embodiments, control circuitry 304 may accept user input to reposition and/or resize PIP window 804. In some embodiments, control circuitry 304 may automatically reposition and/or resize PIP window 804 based on the user's profile or preferences. In some embodiments, once playback of recommended media in PIP window 804 is complete, control circuitry 304 prompts the user with a menu (not shown) having options to replay the content, choose another related content, and/or continue playback of program 802.

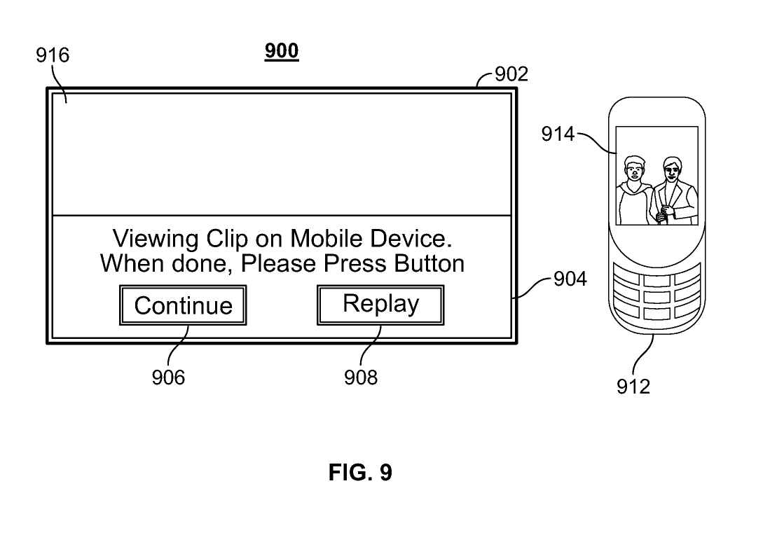

FIG. 9 shows an illustrative embodiment of a cross-platform interactive media system where context-related media is displayed to the user on a device different from where the program is displayed (e.g., a second screen device). Media system 900 includes a user equipment device 902 and a mobile device 912. In some embodiments, the second device may be another user equipment device, a tablet device, a desktop computer, a laptop, or any other suitable device. In some embodiments, media system 900 may include a centralized user profile (e.g., available from cloud-based storage) shared by both user equipment device 902 and mobile device 912. User equipment device 902 shows a menu 904 on top of program 916. When the user selects, e.g., option 606 (“NOW”), to view the recommended content, control circuitry 304 sends instructions to mobile device 912 to display the content to the user on display 914. In some embodiments, control circuitry 304 may display a menu (not shown) to the user to select the device for playback of the recommended content. In some embodiments, control circuitry 304 automatically selects the device for playback of the recommended content based on the centralized user profile. Program 916 may be paused at the point playback of the recommended content was initiated, and show the last viewed frame of the program. Alternatively, a blank frame, a logo, or any other suitable screen may be displayed in place of program 916.

In some embodiments, once playback of recommended media on mobile device 912 is complete, control circuitry 304 prompts the user with a menu 904 on user equipment device 916 with option 906 (“CONTINUE”) and option 908 (“REPLAY”). If the user selects option 908, control circuitry 304 resends instructions to mobile device 912 to display the content to the user on display 914. If the user selects option 906, control circuitry 304 may automatically resume playback of program 916 from a position previously saved when playback of the recommended content was initiated on mobile device 912. In some embodiments, control circuitry 304 automatically determines an appropriate course of action based on the centralized user profile.

In some embodiments, control circuitry 304 sends instructions to mobile device 912 to display menu 904 on display 914 instead of user equipment device 902. In some embodiments, menu 904 is generated by mobile device 912 itself. In such circumstances, mobile device 912 receives a selection of a media asset from the user and searches for content that provides background information or context for the selected media asset. In some embodiments, mobile device 912 searches for content based on the centralized user profile. For example, the centralized user profile may indicate a preference for video clips, and mobile device 912 may focus primarily on searching for video clips. In another example, the centralized user profile may indicate a preference for news media, and mobile device 912 may focus primarily on searching for news media. Similar to user equipment device 902, mobile device 912 may display a menu (not shown) to the user to select the device for playback of the content or automatically select the playback device based on the centralized user profile. For example, the user may select user equipment device 902 for playback of the context-related content. Mobile device 912 may send instructions to control circuitry 304 to display the content in, e.g., an overlay, a PIP window, full-screen mode, or any other suitable display mode. The appropriate selection of display mode may be based on the centralized user profile. In some embodiments, once playback of the content on user equipment device 902 is complete, mobile device 912 sends instructions to control circuitry 304 to automatically resume playback of program 916 from a position previously saved before playback of the content was initiated on user equipment device 902.

FIG. 10A shows an illustrative data structure for providing context-related information to a user of an interactive media guidance application. In particular, FIG. 10A shows a container 1002 (e.g., a video file container) having a video portion 1004, audio portion 1006, and metadata 1008, which includes the media context data structure. In some embodiments, metadata 1008 includes a link to information to be retrieved from media context data source 424. The information includes context information 1010 and list 1012. Context information 1010 may include a detailed description, context keywords, social network or blog pages, and/or other suitable search parameters for finding related media. List 1012 includes a list of related media to provide background information or context of a program to the user. List 1012 may include the content itself or may include hyperlinks to the content. The content may be retrieved from, e.g., media content source 416, or any other suitable local or remote storage device. Control circuitry 304 may search for and retrieve content based on context information 1010 and list 1012 from a storage device (e.g., storage 308) or from an external remote source (e.g., a website on the Internet). In the embodiment shown, metadata 1008 includes context information for the entire file container 1002. Metadata 1008 may include time positions for correlating metadata with the relevant position in video 1004 and audio 1006. An alternative embodiment that interleaves metadata through file container 1002 is discussed below.

FIG. 10B shows an illustrative data structure for providing context-related information to a user of an interactive media guidance application. In particular, FIG. 10A shows a container 1050 (e.g., a video file container) having video frames 1056, audio frames 1052, and metadata 1054, which includes the media context data structure. In some embodiments, metadata 1054 includes a link to information to be retrieved from media context data source 424. Metadata may include context information and/or a list of content, as described above in relation to FIG. 10A. Context information may include a detailed description, context keywords, social network or blog pages, and/or other suitable search parameters for finding related media. The list of content may include related media to provide background information or context of a program to the user. The list may include the content itself or may include hyperlinks to the content. Control circuitry 304 may search for and retrieve content based on the context information and/or the list of content from a storage device (e.g., storage 308) or from an external remote source (e.g., a website on the Internet). In the embodiment shown, multiple, different instances of metadata 1054 are interleaved through container 1050. In particular, metadata 1054 is provided for scene 1058, which includes a specified number of video and audio frames. Metadata 1054 includes context information and/or related content only relevant to scene 1058. This configuration may allow for easy access to the metadata and its included media context data structure. Multiple instances of metadata 1054 may be interleaved through file container 1050 as necessary.

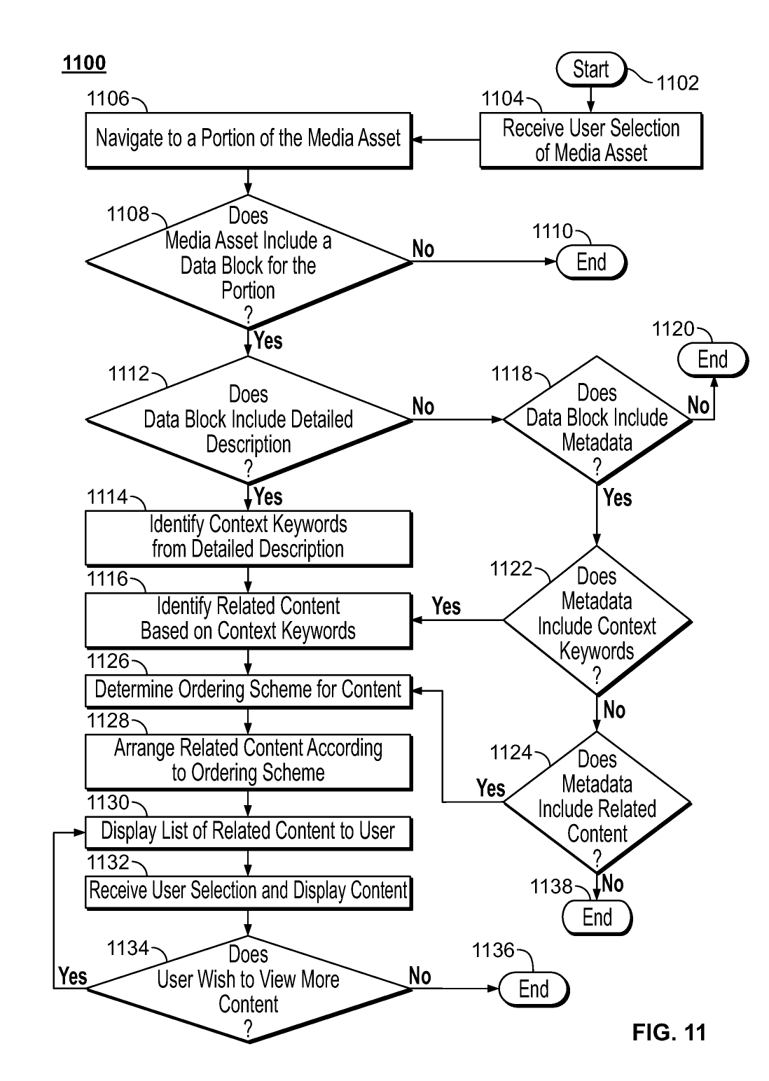

FIG. 11 shows an illustrative flow diagram for providing a context for media content being viewed by the user of an interactive media guidance application. At step 1104, a user equipment device (e.g., user equipment device 300) receives user selection of a media asset via a user input device (e.g., user input interface 310). At step 1106, control circuitry 304 initiates playback of the media asset. Step 1106 may be skipped in certain embodiments, e.g., the embodiment discussed in relation to FIG. 5A. In this embodiment, related content is shown in response to selection of media asset, and therefore, playback is initiated at some point after showing the related content to the user.

At step 1108, control circuitry 304 checks whether the media asset includes a data block (e.g., metadata 1054 including a media context data structure). If a data block is not available, at step 1110, control circuitry 304 terminates the search for related content. If a data block is found, at step 1112, control circuitry 304 checks for a detailed description in the data block. If a detailed description is found, at step 1114, control circuitry 304 identifies context keywords based on the detailed description, and at step 1116, identifies related content based on the context keywords. In some embodiments, control circuitry 304 determines the context for the media asset by searching a social network or a blog for context keywords and/or content. This search may be performed in addition to or in lieu of step 1116. The related content may be located in media content source 416 or another suitable local or remote media source. At step 1126, control circuitry 304 determines an ordering scheme for the related content. Control circuitry 304 may select an ordering scheme automatically (e.g., default selection, previously selected, or another suitable option) or receive criteria from the user for the ordering scheme. The ordering scheme may be based on one or more criteria such as date, length, type of media, source, ratings, number of views, or any other suitable criteria or a combination thereof. For example, the ordering scheme may arrange the related content in chronological or reverse chronological order. Other suitable examples are described above in relation to FIGS. 5A and 5B. At step 1128, control circuitry 304 gathers the related content and arranges them in a playlist based on the selected ordering scheme. At step 1130, control circuitry 304 displays the playlist of the related content to the user.

If a detailed description (or social network or blog page) is not found in the data block at step 1112, at step 1118, control circuitry 304 checks for metadata included in the data block. If none is found, at step 1120, control circuitry 304 terminates the search for related content. Otherwise, at step 1122, control circuitry 304 checks for context keywords already included in the data block. If found, at step 1116, control circuitry 304 uses the context keywords to identify related content based on the context keywords. The related content may be located in media content source 416 or another suitable local or remote media source. At step 1126, control circuitry 304 determines an ordering scheme for the related content. Control circuitry 304 may select an ordering scheme automatically (e.g., default selection, previously selected, or another suitable option) or receive criteria from the user for the ordering scheme. The ordering scheme may be based on one or more criteria such as date, length, type of media, source, ratings, number of views, or any other suitable criteria or a combination thereof. For example, the ordering scheme may arrange the related content in chronological or reverse chronological order. Other suitable examples are described above in relation to FIGS. 5A and 5B. At step 1128, control circuitry 304 gathers the related content and arranges them in a playlist based on the selected ordering scheme. At step 1130, control circuitry 304 displays the playlist of the related content to the user.

If context keywords are not found in the data block at step 1122, at step 1124, control circuitry 304 checks for one or more related content, a list of related content, or hyperlinks to related content in the data block. If none is found, at step 1138, control circuitry 304 terminates the search for related content. If related content is found, at step 1126, control circuitry 304 determines an ordering scheme for the related content. Control circuitry 304 may select an ordering scheme automatically (e.g., default selection, previously selected, or another suitable option) or receive criteria from the user for the ordering scheme. The ordering scheme may be based on one or more criteria such as date, length, type of media, source, ratings, number of views, or any other suitable criteria or a combination thereof. For example, the ordering scheme may arrange the related content in chronological or reverse chronological order. Other suitable examples are described above in relation to FIGS. 5A and 5B. At step 1128, control circuitry 304 gathers the related content and arranges them in a playlist based on the selected ordering scheme. At step 1130, control circuitry 304 displays the playlist of the related content to the user.

At step 1132, control circuitry 304 receives user selection of a related content to view via a user input device (e.g., user input interface 310). The related content may be shown to the user according to one or more of the embodiments described in relation to FIGS. 5A-9. Once playback of the related content is completed, at step 1134, control circuitry 304 prompts the user to view additional related content or continue playback of the media asset. If the user selects to view further content, the flow returns to step 1130, where control circuitry 304 again displays the playlist of the related content to the user. If the user selects to return to the media asset, at step 1136, control circuitry 304 resumes playback of the media asset from where it was left off. In some embodiments, step 1134 may be skipped, and control circuitry 304 may resume playback of the media asset once the user has viewed the related content.

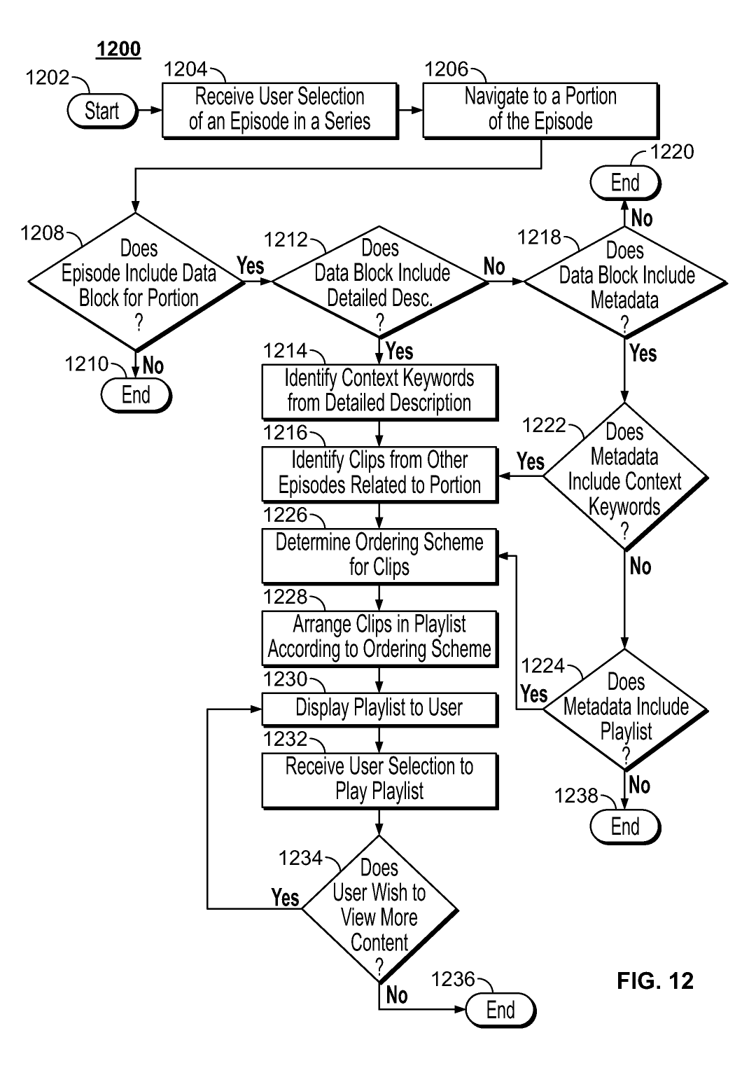

FIG. 12 shows an illustrative flow diagram for providing a context for an episode of a series being viewed by the user of an interactive media guidance application. At step 1204, a user equipment device (e.g., user equipment device 300) receives user selection of an episode of a series via a user input device (e.g., user input interface 310). At step 1206, control circuitry 304 initiates playback of the episode. Step 1206 may be skipped in certain embodiments, e.g., the embodiment discussed in relation to FIG. 6. In this embodiment, related content is shown in response to selection of the episode, and therefore, playback is initiated at some point after showing the related content to the user.

At step 1208, control circuitry 304 checks whether the episode includes a data block (e.g., metadata 1054 including a media context data structure). If a data block is not available, at step 1210, control circuitry 304 terminates the search for related content. If a data block is found, at step 1212, control circuitry 304 checks for a detailed description in the data block. If a detailed description is found, at step 1214, control circuitry 304 identifies context keywords based on the detailed description, and at step 1216, identifies related content, e.g., clips from other episodes of the series, based on the context keywords. In some embodiments, control circuitry 304 determines the context for the episode by searching a social network or a blog for context keywords and/or content. This search may be performed in addition to or in lieu of step 1216. The related content may be located in media content source 416 or another suitable local or remote media source. At step 1226, control circuitry 304 determines an ordering scheme for the related content. Control circuitry 304 may select an ordering scheme automatically (e.g., default selection, previously selected, or another suitable option) or receive criteria from the user for the ordering scheme. The ordering scheme may be based on one or more criteria such as date, length, type of media, source, ratings, number of views, or any other suitable criteria or a combination thereof. For example, the ordering scheme may arrange the related content in chronological or reverse chronological order. Other suitable examples are described above in relation to FIGS. 5A and 5B. At step 1228, control circuitry 304 gathers the related content and arranges them in a playlist based on the selected ordering scheme. At step 1230, control circuitry 304 displays the playlist of the related content, e.g., clips from other episodes of the series, to the user.

If a detailed description (or social network or blog page) is not found in the data block at step 1212, at step 1218, control circuitry 304 checks for metadata included in the data block. If none is found, at step 1220, control circuitry 304 terminates the search for related content. Otherwise, at step 1222, control circuitry 304 checks for context keywords already included in the data block. If found, at step 1216, control circuitry 304 uses the context keywords to identify related content based on the context keywords. The related content may be located in media content source 416 or another suitable local or remote media source. At step 1226, control circuitry 304 determines an ordering scheme for the related content. Control circuitry 304 may select an ordering scheme automatically (e.g., default selection, previously selected, or another suitable option) or receive criteria from the user for the ordering scheme. The ordering scheme may be based on one or more criteria such as date, length, type of media, source, ratings, number of views, or any other suitable criteria or a combination thereof. For example, the ordering scheme may arrange the related content in chronological or reverse chronological order. Other suitable examples are described above in relation to FIGS. 5A and 5B. At step 1228, control circuitry 304 gathers the related content and arranges them in a playlist based on the selected ordering scheme. At step 1230, control circuitry 304 displays the playlist of the related content, e.g., clips from other episodes of the series, to the user.

If context keywords are not found in the data block at step 1222, at step 1224, control circuitry 304 checks for one or more related content, a list of related content, or hyperlinks to related content in the data block. If none is found, at step 1238, control circuitry 304 terminates the search for related content. If related content is found, at step 1224, control circuitry 304 determines an ordering scheme for the related content. Control circuitry 304 may select an ordering scheme automatically (e.g., default selection, previously selected, or another suitable option) or receive criteria from the user for the ordering scheme. The ordering scheme may be based on one or more criteria such as date, length, type of media, source, ratings, number of views, or any other suitable criteria or a combination thereof. For example, the ordering scheme may arrange the related content in chronological or reverse chronological order. Other suitable examples are described above in relation to FIGS. 5A and 5B. At step 1226, control circuitry 304 determines an ordering scheme for the related content. Control circuitry 304 may select an ordering scheme automatically (e.g., default selection, previously selected, or another suitable option) or receive criteria from the user for the ordering scheme. The ordering scheme may be based on one or more criteria such as date, length, type of media, source, ratings, number of views, or any other suitable criteria or a combination thereof. For example, the ordering scheme may arrange the related content in chronological or reverse chronological order. Other suitable examples are described above in relation to FIGS. 5A and 5B. At step 1228, control circuitry 304 gathers the related content and arranges them in a playlist based on the selected ordering scheme. At step 1230, control circuitry 304 displays the playlist of the related content, e.g., clips from other episodes of the series, to the user.

At step 1232, control circuitry 304 receives user selection of a related content to view via a user input device (e.g., user input interface 310). The related content may be shown to the user according to one or more of the embodiments described in relation to FIGS. 5A-9. Once playback of the related content is completed, at step 1234, control circuitry 304 prompts the user to view additional related content or continue playback of the episode. If the user selects to view further content, the flow returns to step 1230, where control circuitry 304 again displays the playlist of the related content to the user. If the user selects to return to the episode, at step 1236, control circuitry 304 resumes playback of the episode from where it was left off. In some embodiments, step 1234 may be skipped, and control circuitry 304 may resume playback of the episode once the user has viewed the related content.

It should be understood that the above steps of the flow diagrams of FIGS. 11 and 12 may be executed or performed in any order or sequence not limited to the order and sequence shown and described in the figures. Also, some of the above steps of the flow diagrams of FIGS. 11 and 12 may be executed or performed substantially simultaneously where appropriate or in parallel to reduce latency and processing times.

Based on the embodiments disclosed above, three further examples of systems and methods for enhancing viewing experience of a user are described below. In some implementations, user equipment device 300 receives user selection of a media asset via user input interface 310. In response to the selection, control circuitry 304 checks whether the media asset includes a data block (e.g., metadata 1054 including a media context data structure). Control circuitry 304 retrieves the media context data structure and extracts detailed description, context keywords, social network or blog pages, and/or a list of related content. In some embodiments, the media context data structure includes hyperlinks to social network or blog pages. In some embodiments, the list of related content includes hyperlinks to media available from media content source 416, or any other suitable local or remote storage device. Based on the extracted information, control circuitry 304 may search for and retrieve content from a storage device (e.g., storage 308) or from an external remote source (e.g., a website on the Internet). The related content may include video clips, audio clips, text documents, news articles, images, or any other suitable media. Control circuitry 304 may display the related content on user equipment device 300.

In some embodiments, control circuitry 304 determines an ordering scheme for the related content. Control circuitry 304 may select an ordering scheme automatically (e.g., default selection, previously selected, or another suitable option) or receive criteria from the user for the ordering scheme. The ordering scheme may be based on one or more criteria such as date, length, type of media, source, ratings, number of views, or any other suitable criteria or a combination thereof. For example, the ordering scheme may arrange the related content in chronological or reverse chronological order. Other suitable examples are described above in relation to FIGS. 5A and 5B. Control circuitry 304 arranges the related content in a playlist based on the selected ordering scheme and displays the playlist to the user. Control circuitry 304 may receive user selection of a related content to view via user input interface 310. The related content may be shown to the user according to one or more of the embodiments described in relation to FIGS. 5A-9. Once playback of the related content is completed, control circuitry 304 prompts the user to view additional related content or continue playback of the media asset. If the user selects to view further content, control circuitry 304 again displays the playlist of the related content to the user. If the user selects to return to the media asset, control circuitry 304 resumes playback of the media asset from where it was left off.

In some implementations, user equipment device 300 operates in conjunction with a remote server to perform searches for related content. User equipment 300 receives user selection of a media asset via user input interface 310. In response to the selection, control circuitry 304 checks whether the media asset includes a data block (e.g., metadata 1054 including a media context data structure). Control circuitry 304 retrieves the media context data structure, extracts detailed description, context keywords, social network or blog pages, and/or a list of related content, and forwards the extracted information to the remote server. Based on the extracted information, the remote server may search for and locate content on a storage device (e.g., storage 308) or on an external remote source (e.g., a website on the Internet). The related content may include video clips, audio clips, text documents, news articles, images, or any other suitable media. Control circuitry 304 may determine an ordering scheme for the related content. Control circuitry 304 may select an ordering scheme automatically (e.g., default selection, previously selected, or another suitable option) or receive criteria from the user for the ordering scheme. The ordering scheme may be based on one or more criteria such as date, length, type of media, source, ratings, number of views, or any other suitable criteria or a combination thereof. For example, the ordering scheme may arrange the related content in chronological or reverse chronological order. Other suitable examples are described above in relation to FIGS. 5A and 5B. In some embodiments, control circuitry 304 receives a list of the related content from the remote server and arranges the related content in a playlist according to the ordering scheme. In some embodiments, control circuitry 304 transmits the selected ordering scheme to the remote server. The remote server arranges the related content in a playlist based on the selected ordering scheme and sends the playlist of related content to user equipment device 300 for display to the user.

Control circuitry 304 may receive user selection of a related content to view via user input interface 310. The related content may be downloaded or streamed from its source storage device directly to user equipment device 300. Alternatively, the remote server may retrieve the related content and download or stream the content to the user equipment device 300. The related content may be shown to the user according to one or more of the embodiments described in relation to FIGS. 5A-9. Once playback of the related content is completed, control circuitry 304 prompts the user to view additional related content or continue playback of the media asset. In such a case, control circuitry 304 may request an updated playlist from the remote server that includes any additional content made available since the last search was performed. If the user selects to view further content, control circuitry 304 displays the updated playlist of the related content to the user. If the user selects to return to the media asset, control circuitry 304 resumes playback of the media asset from where it was left off.

In some implementations, user equipment device 300 operates in conjunction with a second screen device, e.g., mobile device 912, to provide context-related content to a user of an interactive media guidance application. The second device may be another user equipment device, a tablet device, a desktop computer, a laptop, or any other suitable device. Mobile device 912 receives user selection of a media asset and searches for content that provides background information or context for the selected media asset. In response to the selection, mobile device 912 checks whether the media asset includes a data block (e.g., metadata 1054 including a media context data structure). Mobile device 912 retrieves the media context data structure, extracts detailed description, context keywords, social network or blog pages, and/or a list of related content. Based on the extracted information, mobile device 912 searches for and locates content on a storage device (e.g., storage 308) or on an external remote source (e.g., a website on the Internet). The related content may include video clips, audio clips, text documents, news articles, images, or any other suitable media. In some embodiments, mobile device 912 employs a remote server to perform the search for related content based on the extracted information.

Mobile device 912 determines an ordering scheme for the related content. Mobile device 912 may select an ordering scheme automatically (e.g., default selection, previously selected, or another suitable option) or receive criteria from the user for the ordering scheme. The ordering scheme may be based on one or more criteria such as date, length, type of media, source, ratings, number of views, or any other suitable criteria or a combination thereof. For example, the ordering scheme may arrange the related content in chronological or reverse chronological order. Other suitable examples are described above in relation to FIGS. 5A and 5B. Mobile device 912 arranges the related content in a playlist based on the selected ordering scheme, displays the playlist of related content to the user, and receives user selection of a related content to view. The related content may be downloaded or streamed from its source storage device directly to mobile device 912. In embodiments employing a remote server that searches for related content, the remote server may retrieve the related content and download or stream the content to mobile device 912. The related content may be shown to the user according to one or more of the embodiments described in relation to FIGS. 5A-9. In some embodiments, mobile device 912 displays a menu to the user to select a device prior to playback of related content. For example, the user may select user equipment device 300 for playback of the context-related content instead of mobile device 912. Mobile device 912 sends instructions to control circuitry 304 of user equipment device 300 to display the content in, e.g., an overlay, a PIP window, full-screen mode, or any other suitable display mode.

Once playback of the related content is completed, mobile device 912 prompts the user to view additional related content or continue playback of the media asset. If the user selects to view further content, mobile device 912 again displays the playlist of related content to the user. If the user selects the option to return to the media asset, mobile device 912 resumes playback of the media asset. In some embodiments, once playback of the related content on mobile device 912 is complete, mobile device 912 sends instructions to control circuitry 304 to automatically resume playback of the media asset on user equipment device 300.

It will be appreciated that while the discussion of media content has focused on video content, the principles of media guidance can be applied to other types of media content, such as music, images, etc.

The foregoing is merely illustrative of the principles of the present invention, and various modifications can be made by those skilled in the art without departing from the scope and spirit of the invention. The above described embodiments of the present invention are presented for purposes of illustration and not of limitation, and the present invention is limited only by the claims which follow.

1. A method for enhancing viewing experience for a user of an interactive media guidance application implemented on control circuitry, comprising:
receiving user selection of a media asset to he viewed by the user;
analyzing the media asset to determine, using the control circuitry, a context for a portion of the media asset;
identifying, using the control circuitry, content related to the portion of the media asset based on the context, wherein the content is different from the media asset;
determining an ordering scheme for the identified content;
arranging the content in a playlist based on the ordering scheme; and
causing the playlist to be played in response to the user selection of the media asset.

2. The method of claim 1, wherein the media asset includes an episode of a series and the identified content includes a plurality of clips from other episodes in the series.

3. The method of claim 1, wherein the context relates to background information for the user when viewing an event included in the portion of the media asset.

4. The method of claim 1, wherein the context relates to content that precedes or follows an event included in the portion of the media asset and clarifies a meaning of the event to the user.

5. The method of claim 1, wherein determining the context for the portion of the media asset includes identifying a keyword based on a detailed description of the portion of the media asset.

6. The method of claim 1, further comprising:
displaying to the user an option to play the playlist; and
playing the playlist in response to user selection of the option.

7. The method of claim 1, further comprising automatically determining when to play the playlist during playback of the portion of the media asset.

8. The method of claim 1, wherein a criteria for the ordering scheme is selected from the group consisting of date, length, type of media, source, ratings, and number of views.

9. The method of claim 1, wherein the portion of the media asset is displayed on a first device and the playlist is played on a second device different from the first device.

10. The method of claim 1, further comprising searching a social network to identify the context based on the media asset.

11. A system for enhancing viewing experience for a user of an interactive media guidance application, comprising:
control circuitry configured to:
receive user selection of a media asset to be viewed by the user;
analyze the media asset to determine a context for a portion of the media asset;
identify content related to the portion of the media asset based on the context, wherein the content is different from the media asset;
determine an ordering scheme for the identified content;
arrange the content in a playlist based on the ordering scheme; and
play the playlist in response to the user selection of the media asset.

12. The system of claim 11, wherein the media asset includes an episode of a series and the identified content includes a plurality of clips from other episodes in the series.

13. The system of claim 11, wherein the context relates to background information for the user when viewing an event included in the portion of the media asset.

14. The system of claim 11, wherein the context relates to content that precedes or follows an event included in the portion of the media asset and clarifies a meaning of the event to the user.

15. The system of claim 11, wherein determining the context for the portion of the media asset includes identifying a keyword based on a detailed description of the portion of the media asset.

16. The system of claim 11, wherein the control circuitry is further configured to:
display to the user an option to play the playlist; and
play the playlist in response to user selection of the option.

17. The system of claim 11, wherein the control circuitry is further configured to:
automatically determine when to play the playlist during playback of the portion of the media asset.

18. The system of claim 11, wherein a criteria for the ordering scheme is selected from the group consisting of date, length, type of media, source, ratings, and number of views.

19. The system of claim 11, wherein the portion of the media asset is displayed on a first device and the playlist is played on a second device different from the first device.

20. The system of claim 11, wherein the control circuitry is further configured to:
search a social network to identify the context based on the media asset.

21-30. (canceled)
